(19) United States
(12) Patent Application Publication
(10) Pub. No.: US 2008/0266279 A1
(43) Pub. Date: Oct. 30, 2008

(54) PLASMA DISPLAY APPARATUS AND METHOD OF DRIVING THE SAME

(76) Inventors: Hyohun SON, Seoul (KR); Jeongpil Choi, Seoul (KR)

Correspondence Address: KED & ASSOCIATES, LLP, P.O. Box 221200, Chantilly, VA, 20153-1200, US

(21) Appl. No.: 12/109,796

(22) Filed: Apr. 25, 2008

(30) Foreign Application Priority Data
Apr. 27, 2007 (KR) 10-2007-0041623
Apr. 30, 2007 (KR) 10-2007-0042142

(51) Int. Cl. G06F 3/038; G09G 3/28

(52) U.S. Cl. 345/211; 345/60

(57) ABSTRACT

A plasma display apparatus and a method of driving the same are disclosed. The plasma display apparatus includes a data driver that supplies a data signal to a plasma display panel and an energy supply/recovery unit. The energy supply/recovery unit includes an energy supply unit including a first coil connected to the data driver and supplying an energy to the plasma display panel, an energy recovery unit including a second coil connected to the data driver and recovering an energy from the plasma display panel, and an energy storing unit connected to the energy supply unit and the energy recovery unit. The energy storing unit stores the supplied energy or the recovered energy.

This application claims the benefit of Korean Patent Application Nos. 10-2007-0041623 and 10-2007-0042142 filed on Apr. 27, 2007 and Apr. 30, 2007, which are hereby incorporated by reference.

### BACKGROUND OF THE DISCLOSURE

1. Field of the Disclosure

An exemplary embodiment relates to a plasma display apparatus and a method of driving the same.

2. Description of the Background Art

A plasma display apparatus generally includes a plasma display panel displaying an image, and a driver attached to the rear of the plasma display panel to drive the plasma display panel.

The plasma display panel includes a front substrate and a rear substrate which are spaced apart from each other at a given interval therebetween, and barrier ribs for forming a plurality of discharge cells between the front substrate and the rear substrate. Each discharge cell is filled with an inert gas containing a main discharge gas such as neon (Ne), helium (He) or a mixture of Ne and He, and a small amount of xenon (Xe). Red, green, and blue discharge cells form one pixel.

When the plasma display panel is discharged by a high frequency voltage, the inert gas generates vacuum ultraviolet rays, which thereby cause phosphors formed between the barrier ribs to emit light, thus displaying an image.

The plasma display panel includes a plurality of electrodes, for instance, a scan electrode, a sustain electrode, and an address electrode. The drivers for supplying driving voltages to the electrodes of the plasma display panel are connected to the electrodes, respectively.

When the plasma display panel is driven, each driver supplies a driving signal such as a reset signal, a scan signal, and a sustain signal to the electrode during a predetermined period, for example, a reset period, an address period, and a sustain period to emit light inside the discharge cells. Since the above-described plasma display panel can be manufactured to be thin and light, the plasma display panel has been considered as a next generation display apparatus.

An energy recovery circuit supplies a power required in a discharge to the electrode and recovers an energy from the electrode. Therefore, the energy recovery circuit is necessary to perform a sustain drive. The energy recovery circuit is also used to increase the drive efficiency of a data driver.

### SUMMERY OF THE DISCLOSURE

In one aspect, a plasma display apparatus comprises a data driver that supplies a data signal to a plasma display panel, and an energy supply/recovery unit, the energy supply/recovery unit including an energy supply unit including a first coil connected to the data driver and supplying an energy to the plasma display panel, an energy recovery unit including a second coil connected to the data driver and recovering an energy from the plasma display panel, and an energy storing unit connected to the energy supply unit and the energy recovery unit, the energy storing unit storing the supplied energy or the recovered energy.

In another aspect, a method of driving a plasma display apparatus for supplying a data signal to a plasma display panel, wherein the data signal includes a rising period during which a voltage level of the data signal rises to supply the data signal to the plasma display panel, an ON-maintenance period during which the data signal is maintained in an ON-state, a falling period during which the voltage level of the data signal falls, and an OFF-maintenance period during which the data signal is maintained in an OFF-state, the data signal having a predetermined bias voltage during the OFF-maintenance period.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1A shows a first implementation of a plasma display apparatus including a data driver;

FIG. 1B shows an example of a method of driving the plasma display apparatus of FIG. 1A;

FIG. 2A shows a second implementation of a plasma display apparatus including a data driver;

FIG. 2B shows an example of a method of driving the plasma display apparatus of FIG. 2A;

FIG. 3A shows a third implementation of a plasma display apparatus including a data driver;

FIG. 3B shows an example of a method of driving the plasma display apparatus of FIG. 3A;

FIG. 4 shows a fourth implementation of a plasma display apparatus including a data driver;

FIG. 5A shows a fifth implementation of a plasma display apparatus including a data driver;

FIG. 5B shows an example of a method of driving the plasma display apparatus of FIG. 5A;

FIG. 6 shows a sixth implementation of a plasma display apparatus including a data driver;

FIG. 7A shows a 61-circuit of FIG. 6;

FIG. 7B shows an example of a detailed design method of FIG. 7A;

FIGS. 8A and 8B show a seventh implementation of a plasma display apparatus including a data driver;

FIG. 9 shows an eighth implementation of a plasma display apparatus including a data driver;

FIG. 10 shows an example of a method of driving the plasma display apparatus of FIG. 9;

FIG. 11 shows a ninth implementation of a plasma display apparatus including a data driver; and

FIG. 12 shows an example of a method of driving the plasma display apparatus of FIG. 11.

### DETAILED DESCRIPTION OF EMBODIMENTS

Reference will now be made in detail embodiments of the invention examples of which are illustrated in the accompanying drawings.

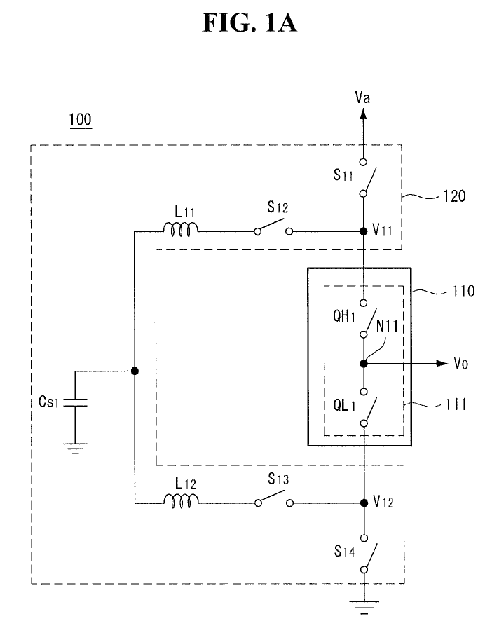

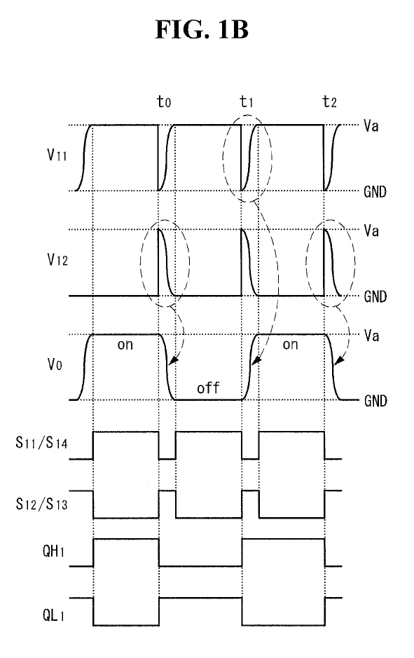

FIG. 1A shows a first implementation of a plasma display apparatus including a data driver.

As shown in FIG. 1A, the plasma display apparatus includes a data driver and an energy supply/recovery unit 100, and the data driver and the energy supply/recovery unit 100 include a data driver 110 and an energy supply/recovery unit 120. The energy supply/recovery unit 120 includes an energy supply unit L11, an energy recovery unit L12, and an energy storing unit CS1. The data driver 110 supplies a data signal to a plasma display panel. The energy supply unit L11 includes a first coil L11 connected to the data driver 110 and supplies an energy to the plasma display panel. The energy recovery unit L12 includes a second coil L12 connected to the data driver 110 and recovers energy from the plasma display panel. The energy storing unit CS1 is connected to the energy supply unit L11 and the energy recovery unit L12 to stores the supplied energy or the recovered energy. The above-described configuration may be applied to implementations of the present invention to be described later.

The energy supply/recovery unit 120 includes a first switch S12 for connecting the energy supply unit L11 to the data driver 110, and a second switch S13 for connecting the energy recovery unit L12 to the data driver 110.

The plasma display apparatus includes a data voltage source Va connected to the energy supply unit L11 to supply a data voltage to the data driver 110, and a ground level voltage source supplying a ground level voltage to the data driver 110.

One terminal of the data driver 110 is connected to an energy supply terminal V11 of the energy supply/recovery unit 120, and the other terminal is connected to an energy recovery terminal V12 of the energy supply/recovery unit 120. Both terminals of the data driver 110 are separated from each other, and energy supply and recovery operations can be simultaneously performed through both terminals of the data driver 110.

The data driver 110 includes an 11-circuit 111. The 11-circuit 111 includes a first high switch QH1 and a first low switch QL1 connected in series. The 11-circuit 111 may include a plurality of high switches and a plurality of low switches.

A node N11 between the first high switch QH1 and the first low switch QL1 is connected to an output terminal Vo. One terminal of the 11-circuit 111 is connected to the energy supply terminal V11 of the energy supply/recovery unit 120, and the other terminal is connected to the energy recovery terminal V12 of the energy supply/recovery unit 120. Both terminals of the 11-circuit 111 are separated from each other, and energy supply and recovery operations can be simultaneously performed through both terminals of the 11-circuit 111.

The energy supply/recovery unit 120 includes an 11-switch S11, a 12-switch S12, an 11-inductor L11, a 13-switch S13, a 14-switch S14, a 12-inductor L12, and a first capacitor CS1.

The 11-switch S11 is connected between the data voltage source Va and the energy supply terminal V11. One terminal of the 12-switch S12 is connected to the energy supply terminal V11, and the other terminal is connected to one terminal of the 11-inductor L11. The 14-switch S14 is connected between a ground level and the energy recovery terminal V12. One terminal of the 13-switch S13 is connected to the energy recovery terminal V12, and the other terminal is connected to one terminal of the 12th inductor L12. One terminal of the first capacitor CS1 is commonly connected to the other terminal of the 11-inductor L11 and the other terminal of the 12-inductor L12, and the other terminal is connected to a ground level. The switches shown in FIG. 1A may use a field effect transistor (FET).

FIG. 1B shows an example of a method of driving the plasma display apparatus of FIG. 1A.

As shown in FIG. 1B, the energy recovered from the plasma display panel is stored in the first capacitor CS1 through the first low switch QL1, the 13-switch S13, and the 12-inductor L12. The energy is supplied to the plasma display panel through the 11-inductor L11, the 12-switch S12, and the first high switch QH1.

The driving method of the plasma display apparatus of FIG. 1B can simultaneously perform the energy supply and recovery operations. In other words, although an output state of each channel (data electrode) is different from each other, the energy supply and recovery operations can be simultaneously performed because energy supply and recovery paths are separated from each other. Accordingly, the energy supply and recovery time can be reduced.

It is assumed that one channel operates in ON-OFF-ON order. So, the first low switch QL1 and the 13-switch S13 are turned on at a time t0, and thus energy may be recovered from the plasma display panel of which a voltage level is the data voltage Va. The first high switch QH1 and the 12-switch S12 are turned on at a time t1, and thus the voltage level of the plasma display panel may rise from 0V to the data voltage Va. The above-described operations may be applied to dotted circles of FIG. 1B. It can be seen from the dotted circles that the energy supply and recovery operations can be simultaneously performed through the energy supply terminal V11 and the energy recovery terminal V12. For the above-described operations, the first low switch QL1 has to separate a driving signal by designing a level shifter inside the data driver 110 not to be connected with the ground level voltage.

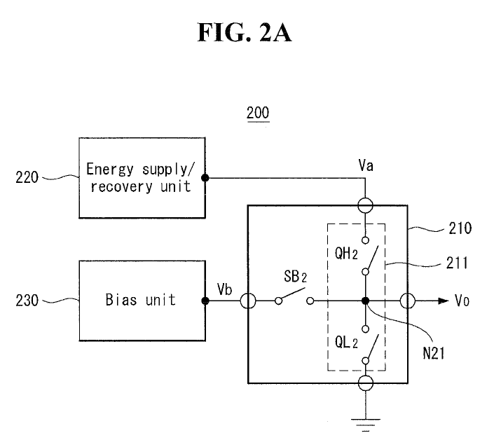

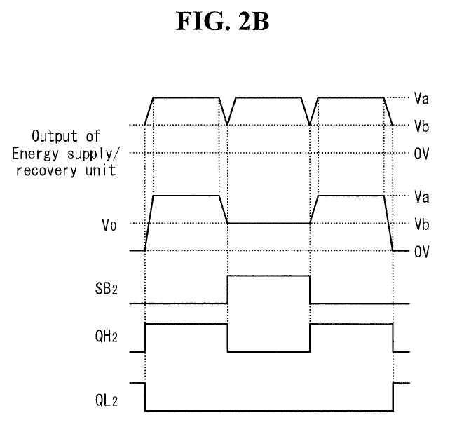

FIG. 2A shows a second implementation of a plasma display apparatus including a data driver.

As shown in FIG. 2A, the plasma display apparatus includes a data driver and an energy supply/recovery unit 200, and the data driver and the energy supply/recovery unit 200 include a data driver 210, an energy supply/recovery unit 220, and a bias unit 230. The data driver 210 includes a 21-circuit 211 and a bias switch SB2. The bias unit 230 supplies a bias voltage to the data driver 210.

The 21-circuit 211 includes a second high switch QH2 and a second low switch QL2 connected in series. The bias switch SB2 is connected between a node N21 between the second high switch QH2 and the second low switch QL2 and the bias unit 230.

The node N21 is connected to an output terminal Vo. One terminal of the 21-circuit 211 is connected to an energy supply terminal of the energy supply/recovery unit 220, and the other terminal is connected to a ground level.

FIG. 2B shows an example of a method of driving the plasma display apparatus of FIG. 2A.

As shown in FIG. 2B, in a data driving method for supplying a data signal to the plasma display panel, the data signal includes a rising period during which a voltage level of the data signal rises, an ON-maintenance period during which the data signal is maintained in an ON-state, a falling period during which the voltage level of the data signal falls, and an OFF-maintenance period during which the data signal is maintained in an OFF-state. In the OFF-maintenance period, the data signal has a predetermined bias voltage Vb. The bias voltage Vb may be greater than a ground level voltage and smaller than a voltage Va capable of generating an address discharge.

The data driver 210 receives an alternating current (AC) voltage Va of the energy supply/recovery unit 220 and is connected to the predetermined bias voltage Vb between 0V and the AC voltage Va through the bias switch SB2. Because an output voltage Vo of the data driver 210 lies in a range between the bias voltage Vb and the AC voltage Va, a driving voltage can be reduced. The bias voltage Vb may be set at a minimum voltage level capable of preventing an erroneous discharge. Although the driving voltage is reduced, operations of the energy supply/recovery unit 220 are possible. Because the bias voltage Vb takes the place of the ground level voltage in the energy supply/recovery unit 220, power consumption can be reduced.

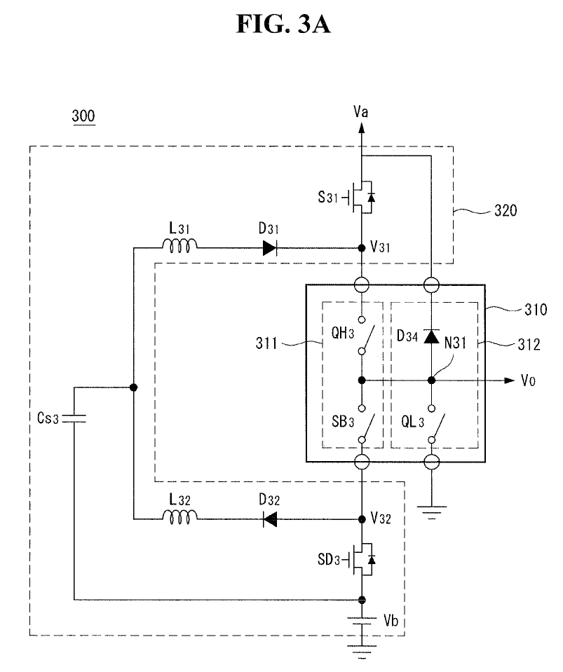

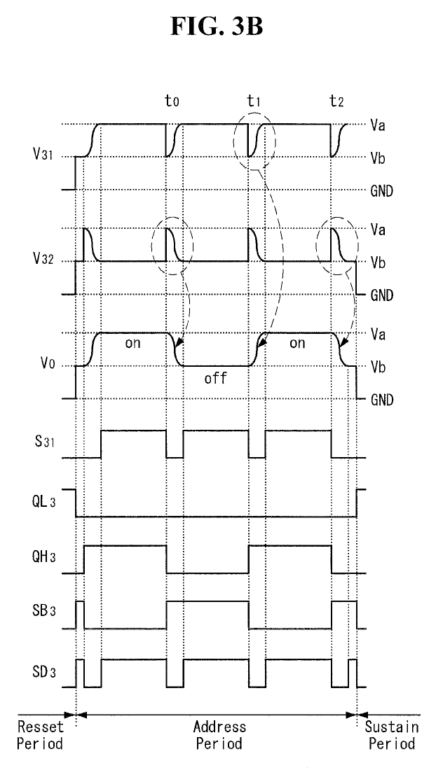

FIG. 3A shows a third implementation of a plasma display apparatus including a data driver.

As shown in FIG. 3A, the plasma display apparatus includes a data driver and an energy supply/recovery unit 300, and the data driver and the energy supply/recovery unit 300 include a data driver 310 and an energy supply/recovery unit 320. The data driver 310 includes a 31-circuit 311 and a 32-circuit 312.

The plasma display apparatus may include a bias voltage source Vb connected to an energy supply unit L32 to supply a bias voltage Vb to the data driver 310. The bias voltage Vb may be greater than a ground level voltage and smaller than a voltage Va capable of generating an address discharge.

The 31-circuit 311 includes a third high switch QH3 and a third bias switch SB3 connected in series. The 32-circuit 312 includes a third diode D34 and a third low switch QL3 connected in series.

A node N31 between the third high switch QH3 and the third bias switch SB3 is connected to an output terminal Vo. One terminal of the 31-circuit 311 is connected to an energy supply terminal V31 of the energy supply/recovery unit 320, and the other terminal is connected to an energy recovery terminal V32 of the energy supply/recovery unit 320. Both terminals of the 31-circuit 311 are separated from each other, and energy supply and recovery operations can be simultaneously performed through both terminals of the 31-circuit 311.

The node N31 between the third diode D34 and the third low switch QL3 is connected to the output terminal Vo. One terminal of the 32-circuit 312 is connected to a data voltage source Va, and the other terminal is connected to a ground level.

The energy supply/recovery unit 320 includes a 31-switch S31, a 31-diode D31, a 31-inductor L31, a 32-switch SD3, a 32-diode D32, a 32-inductor L32, and a third capacitor CS3.

The 31-switch S31 is connected between the data voltage source Va and the energy supply terminal V31. A cathode of the 31-diode D31 is connected to the energy supply terminal V31, and an anode of the 31-diode D31 is connected to one terminal of the 31-inductor L31. The 32-switch SD3 is connected between the bias voltage source Vb and the energy recovery terminal V32. An anode of the 32-diode D32 is connected to the energy recovery terminal V32, and a cathode of the 32-diode D32 is connected to one terminal of the 32-inductor L32. One terminal of the third capacitor Cs3 is connected to the other terminal of the 31-inductor L31 and the other terminal of the 32-inductor L32, and the other terminal is connected to the bias voltage source Vb.

FIG. 3B shows an example of a method of driving the plasma display apparatus of FIG. 3A.

As shown in FIG. 3B, the plasma display apparatus of FIG. 3A can simultaneously perform energy supply and recovery operations by separating energy supply and recovery paths from each other. Each channel (each data electrode) of the data driver 310 can individually perform the energy supply and recovery operations. Because the bias voltage Vb can be employed through the 32-switch SD3, the power consumption can be reduced. The third bias switch SB3 has to operate separately from the ground level using a level shifter inside the data driver 110 so that the bias voltage Vb can be employed through the 32-switch SD3.

The third diode D34 is a clamping diode to a data voltage source Va. The third low switch QL3 is necessary in periods except an address period and is a clamping switch to the ground level voltage.

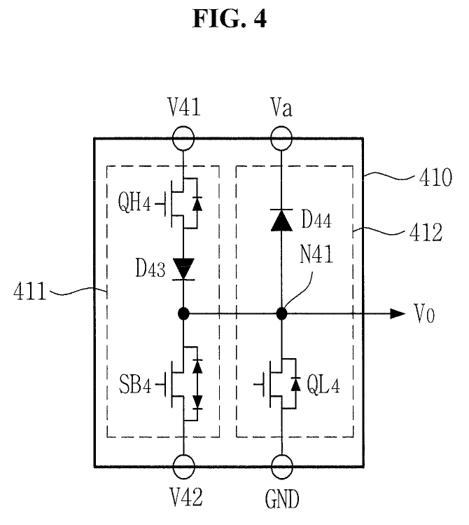

FIG. 4 shows a fourth implementation of a plasma display apparatus including a data driver.

FIG. 4 shows only a data driver 410. Since the remaining parts excluding the data driver 410 from the plasma display apparatus are the same as the parts shown in FIG. 3A, a description thereof is omitted. The data driver 410 includes a 41-circuit 411 and a 42-circuit 412.

The 41-circuit 411 includes a fourth high switch QH4, a blocking diode D43, and a fourth bias switch SB4 connected in series. The blocking diode D43 is connected between the fourth high switch QH4 and the fourth bias switch SB4 in an opposite direction of a body diode of the fourth high switch QH4. The 42-circuit 412 includes a fourth diode D44 and a fourth low switch QL4 connected in series.

A node N41 between the blocking diode D43 and the fourth bias switch SB4 is connected to an output terminal Vo. One terminal of the 41-circuit 411 is connected to an energy supply terminal V41 of an energy supply/recovery unit (not shown), and the other terminal is connected to an energy recovery terminal V42 of the energy supply/recovery unit. Both terminals of the 41-circuit 411 are separated from each other, and energy supply and recovery operations can be simultaneously performed through both terminals of the 41-circuit 411.

The node N41 between the fourth diode D44 and the fourth low switch QL4 is connected to the output terminal Vo. One terminal of the 42-circuit 412 is connected to a data voltage source Va, and the other terminal is connected to a ground level. A body diode of the fourth bias switch SB4 has a bidirectional blocking structure.

The data driver 410 has a plurality of output channels, and the plurality of output channels operate while affecting each other. The blocking diode D43 blocks a forward current of the body diode of the fourth high switch QH4. Although FIG. 4 shows the data driver 410 including only one output channel, when states of two or more output channels are different from each other, the blocking diode D43 can prevent an unnecessary voltage drop of the energy supply terminal V41 so as to simultaneously perform the energy supply and recovery operations. For example, in case that one output Vo1 changes from a “high” state to a “high” state, and the other output Vo2 changes from a “low” state to a “high” state, the output terminal Vo2 starts to operate in a “low” state at a time when energy is supplied to the output terminal Vo2. Therefore, the energy supply terminal V41 starts to operate in a “low” state. However, even if the output terminal Vo1 continuously maintains an output of the “high” state, a voltage drop occurs in the energy supply terminal V41 due to the output Vo2 and an unnecessary voltage drop occurs in the output Vo1. Therefore, the blocking diode D43 is necessary so that the output channels do not affect each other.

The fourth bias switch SB4 needs a blocking diode, but the blocking diode D43 cannot be designed in the fourth bias switch SB4. After a reset operation is completed, the output Vo has to rise from a ground level to the bias voltage Vb at a time when an address operation starts. However, it is difficult to perform the above-described operation because of the blocking diode. Accordingly, the fourth bias switch SB4 has the bidirectional blocking structure without a separate blocking diode.

The fourth diode D44 is a high side clamping diode blocked by the blocking diode D43. Because the fourth low switch QL4 exists in a low side, a separate clamping diode is not necessary.

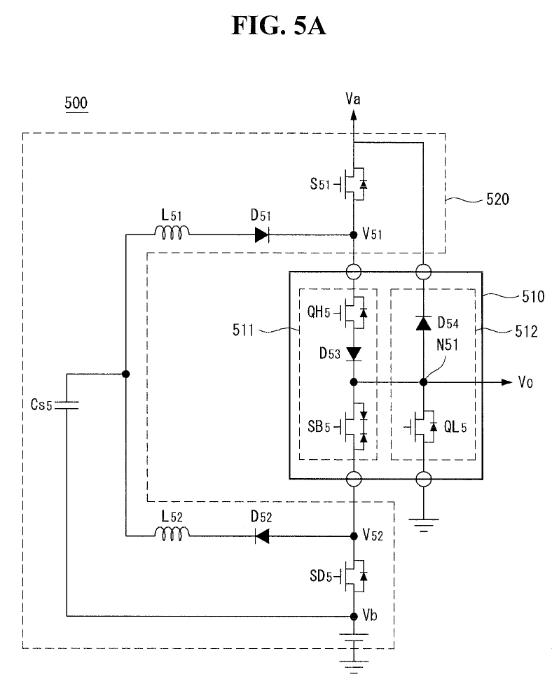

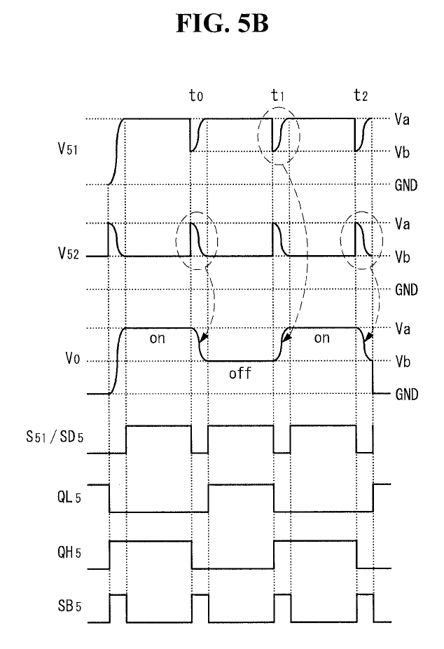

FIG. 5A shows a fifth implementation of a plasma display apparatus including a data driver.

As shown in FIG. 5A, the plasma display apparatus includes a data driver and an energy supply/recovery unit 500, and the data driver and the energy supply/recovery unit 500 include a data driver 510 and an energy supply/recovery unit 520. The data driver 510 includes a 51-circuit 511 and a 52-circuit 512.

Body diodes of a fifth bias switch SB5 have a bidirectional blocking structure in which cathodes of the body diodes are connected to each other. Since the remaining configuration is the same as the configuration shown in FIG. 4, a description thereof is omitted. Since a configuration of the data driver 510 shown in FIG. 5A is merely an example, the data driver 510 is not limited thereto. In FIG. 5A, the fifth bias switch SB5 performs a bidirectional switching operation using the two body diodes, but the fifth bias switch SB5 may perform a bidirectional switching operation (i.e., an operation without properties of a unidirectional diode) in another manner.

FIG. 5B shows an example of a method of driving the plasma display apparatus of FIG. 5A.

As shown in FIG. 5B, the plasma display apparatus of FIG. 5A can simultaneously perform energy supply and recovery operations by separating energy supply and recovery paths from each other. Each channel (each data electrode) of the data driver 510 can individually perform the energy supply and recovery operations. Because the bias voltage Vb can be employed through a 52-switch SD5, the power consumption can be reduced. The fifth bias switch SB5 has to operate separately from the ground level using a level shifter inside the data driver 510 so that the bias voltage Vb can be employed through the 52-switch SD5.

A fifth diode D54 is a clamping diode to a data voltage source Va. A fifth low switch QL5 is necessary in periods except an address period and is a clamping switch to the ground level voltage. A blocking diode D53 prevents a mutual interference when output states such as “high” and “low” states of the data driver 510 are different from each other.

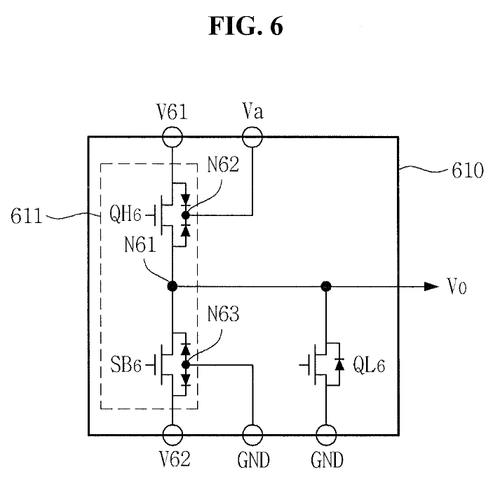

FIG. 6 shows a sixth implementation of a plasma display apparatus including a data driver.

FIG. 6 shows only a data driver 610. Since the remaining parts excluding the data driver 610 from the plasma display apparatus are the same as the parts shown in FIG. 5A, a description thereof is omitted. The plasma display apparatus includes a data driver 610 and an energy supply/recovery unit (not shown). The data driver 610 includes a 61-circuit 611 and a sixth low switch QL6.

The 61-circuit 611 includes a sixth high switch QH6 and a sixth bias switch SB6 connected in series. One terminal of the sixth low switch QL6 is connected to a node N61 between the sixth high switch QH6 and a sixth bias switch SB6, and the other terminal is connected to a ground level.

The node N61 is connected to an output terminal Vo. One terminal of the 61-circuit 611 is connected to an energy supply terminal V61 of an energy supply/recovery unit (not shown), and the other terminal is connected to an energy recovery terminal V62 of the energy supply/recovery unit. Both terminals of the 61-circuit 611 are separated from each other, and energy supply and recovery operations can be simultaneously performed through both terminals of the 61-circuit 611.

Body diodes of the sixth high switch QH6 have a bidirectional blocking structure. Body diodes of the sixth bias switch SB6 have a bidirectional blocking structure in an opposite direction of the body diodes of the sixth high switch QH6.

A node N62 between the body diodes of the sixth high switch QH6 is connected to a data voltage source Va, and a node N63 between the body diodes of the sixth bias switch SB6 is connected to a ground level.

Because the sixth high switch QH6 have a bidirectional blocking structure, a separate clamping diode is not necessary. Because the sixth high switch QH6 and the sixth bias switch SB6 are connected to the data voltage source Va and the ground level in two areas (well pick-up area, well-tie area, or well-plug area) of the sixth high switch QH6 and the sixth bias switch SB6, respectively, a clamping effect can be obtained. Accordingly, a direction of the body diodes of the sixth high switch QH6 and a direction of the body diodes of the sixth bias switch SB6 are opposite.

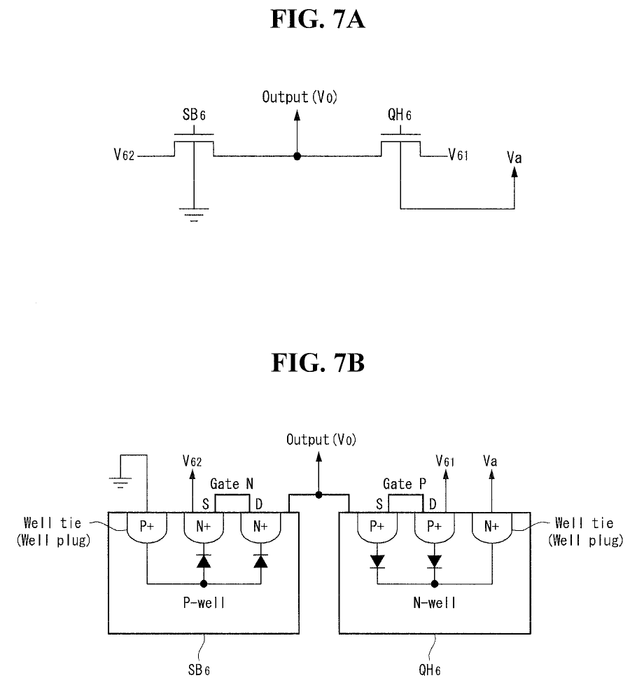

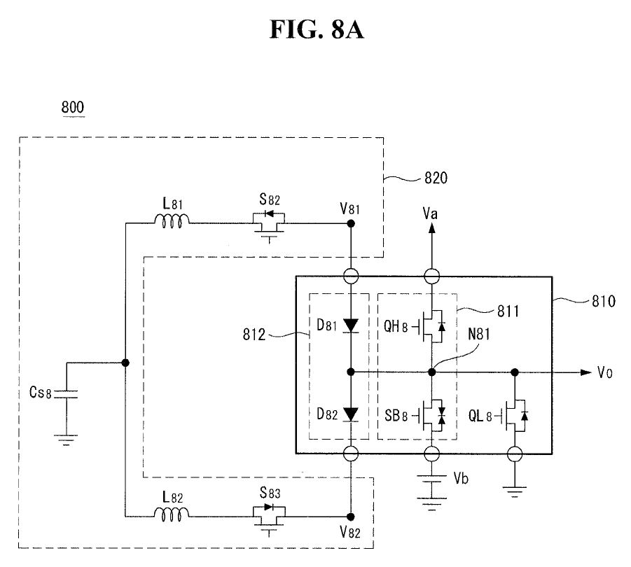

FIG. 7A shows the 61-circuit of FIG. 6, and FIG. 7B shows an example of a detailed design method of FIG. 7A.

As shown in FIGS. 7A and 7B, a bulk of the sixth high switch QH6 has an N-well structure, and a bulk of the sixth bias switch SB6 has a P-well structure. Because a well tie (well plug) area of each of the sixth high switch QH6 and the sixth bias switch SB6 is separated from source and drain regions S and D, the sixth high switch QH6 and the sixth bias switch SB6 are connected to the data voltage source Va and the ground level, respectively. Hence, the sixth high switch QH6 and the sixth bias switch SB6 can function as clamping channel.

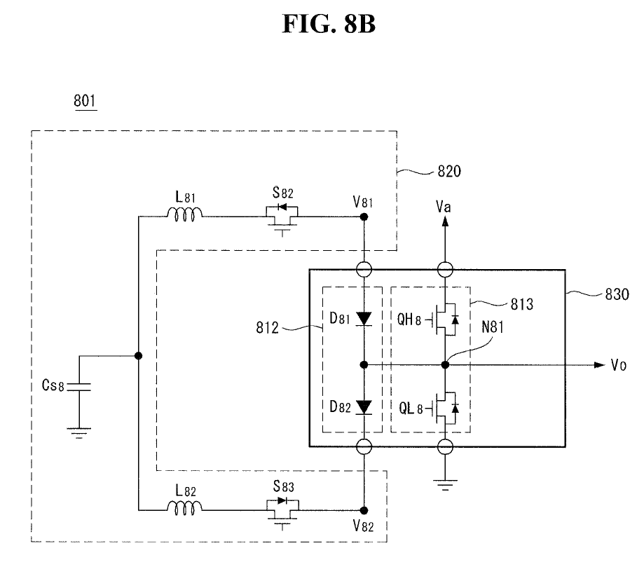

FIGS. 8A and 8B show a seventh implementation of a plasma display apparatus including a data driver.

As shown in FIG. 8A, the plasma display apparatus includes a data driver and an energy supply/recovery unit 800, and the data driver and the energy supply/recovery unit 800 include a data driver 810 and an energy supply/recovery unit 820. The data driver 810 includes an 81-circuit 811, an 82-circuit 812, and an eighth low switch QL8.

The 81-circuit 811 includes an eighth high switch QH8 and an eighth bias switch SB8 connected in series. One terminal of the eighth low switch QL8 is connected to a node N81 between the eighth high switch QH8 and the eighth bias switch SB8, and the other terminal is connected to a ground level. The 82-circuit 812 includes an 81-diode D81 and an 82-diode D82 which are connected in series through the node N81.

The node N81 is connected to an output terminal Vo. One terminal of the 81-circuit 811 is connected to a data voltage source Va, and the other terminal is connected to a bias voltage source Vb.

one terminal of the 82-circuit 812 is connected to an energy supply terminal V81 of the energy supply/recovery unit 820, and the other terminal is connected to an energy recovery terminal V82 of the energy supply/recovery unit 820. Both terminals of the 82-circuit 812 are separated from each other, and energy supply and recovery operations can be simultaneously performed through both terminals of the 61-circuit 611. Body diodes of the eighth bias switch SB8 have a bi-directional blocking structure. The energy supply/recovery unit 820 includes an 82-switch S82, an 81-inductor L81, an 83-switch S83, an 82-inductor L82, and an eighth capacitor CS8.

One terminal of the 82-switch S82 is connected to the energy supply terminal V81, and the other terminal is connected to one terminal of the 81-inductor L81. One terminal of the 83-switch S83 is connected to the energy recovery terminal V82, and the other terminal is connected to one terminal of the 82-inductor L82. One terminal of the eighth capacitor CS8 is connected to the other terminal of the 81-inductor L81 and the other terminal of the 82-inductor L82, and the other terminal is connected to a ground level.

The plasma display apparatus of FIG. 8A basically including three switches and two diodes can obtain the same driving effect as the plasma display apparatus of FIG. 5A. Because the two diodes D81 and D82 are directly connected to the output terminal Vo in FIG. 8A, a separate clamping diode is not necessary. The data voltage source Va and the bias voltage source Vb for supplying a power required to drive may be connected to each other through only a ground switch.

As another structure of the plasma display apparatus shown in FIG. 8A, the plasma display apparatus, as shown in FIG. 8B, includes a data driver and an energy supply/recovery unit 801, and the data driver and the energy supply/recovery unit 801 include a data driver 830 and an energy supply/recovery unit 820. The data driver 830 includes an 83-circuit 813 and an 82-circuit 812. The 83-circuit 813 includes an eighth high switch QH8 and an eighth low switch QL8 connected in series. The 82-circuit 812 includes an 81-diode D81 and an 82-diode D82 which are connected in series through a node N81. The node N81 is connected to an output terminal Vo. One terminal of the 83-circuit 813 is connected to a data voltage source Va, and the other terminal is connected to a ground level. One terminal of the 82-circuit 812 is connected to an energy supply terminal V81 of the energy supply/recovery unit 820, and the other terminal is connected to an energy recovery terminal V82 of the energy supply/recovery unit 820.

Generally, as the number of switches in an integrated circuit (IC) of a driver increases, a percent defective of the driver increases. Accordingly, the plasma display apparatus shown in FIGS. 8A and 8B can reduce a percent defective of the data driver by using the diode instead of the switch.

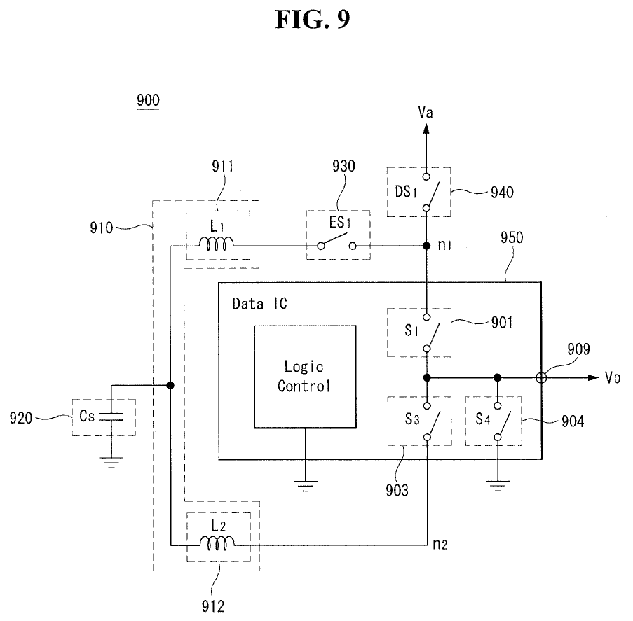

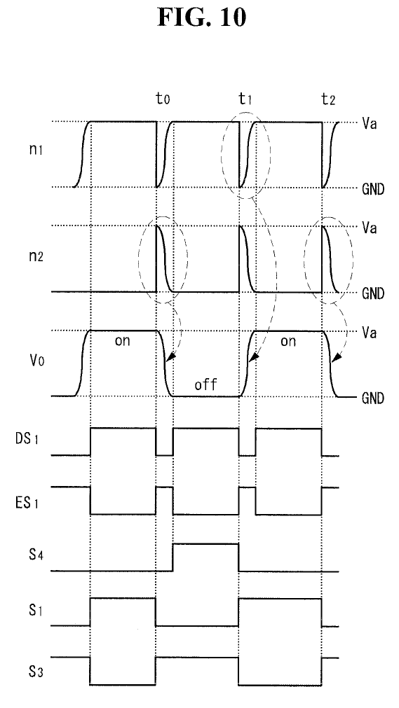

FIG. 9 shows an eighth implementation of a plasma display apparatus including a data driver, and FIG. 10 shows an example of a method of driving the plasma display apparatus of FIG. 9.

As shown in FIG. 9, the plasma display apparatus includes a data driver and an energy supply/recovery unit 900, and the data driver and the energy supply/recovery unit 900 include a data driver 950 and an energy supply/recovery units 910, 920, 930, and 940. One terminal of the data driver 950 is connected to an energy supply terminal n1 of the energy supply/recovery unit 900, and the other terminal is connected to an energy recovery terminal n2 of the energy supply/recovery unit 900. Both terminals of the data driver 950 are separated from each other, and energy supply and recovery operations can be simultaneously performed through both terminals of the data driver 950. The energy supply/recovery unit 900 includes the resonance forming unit 910, the energy storing unit 920, and the switches 930 and 940.

The data driver 950 includes a first switch S1 and 901, a third switch S3 and 903, and a fourth switch S4 and 904. The first switch S1 and 901 is turned on during an address period and is connected to a path for supplying a data voltage Va corresponding to a highest voltage of a data signal or an energy supply path. The third switch S3 and 903 is connected to an energy recovery path. The fourth switch S4 and 904 is connected to a path for supplying a ground level voltage GND corresponding to a lowest voltage of the data signal.

One terminal of the first switch 901 is connected to the data voltage supply path or the energy supply path, and the other terminal is connected to one terminal of the third switch 903. The other terminal of the third switch 903 is connected to the energy recovery path. One terminal of the fourth switch 904 is connected to the other terminal of the first switch 901, and the other terminal is connected to the ground level voltage supply path.

The data driver 950 includes first to fourth terminals. The first terminal forms the energy supply path for receiving the data voltage Va or forming the data signal. The second terminal forms the energy recovery path for forming the data signal. The third terminal forms a path for receiving the ground level voltage GND. The fourth terminal 509 functions as an output terminal of the data driver 950 and is electrically connected to the data electrode of the plasma display panel.

One terminal of the first switch 901 is commonly connected to an energy supply switch ES1 and 930 and a first data voltage switch DS1 and 940 through the first terminal, and the other terminal is commonly connected to one terminal of the third switch 903, one terminal of the fourth switch 904, and the fourth terminal 509. The other terminal of the third switch 903 is directly connected to a second resonance forming unit 912 through the second terminal. The other terminal of the fourth switch 904 is connected to a ground level voltage source for supplying the ground level voltage (ND through the third terminal. A description about the energy supply/recovery units 910, 920, 930, and 940 is omitted.

In FIG. 9, an energy recovery switch is not installed between the data driver 950 and the second resonance forming unit L2 and 912, and the data driver 950 is directly connected to the second resonance forming unit L2 and 912.

Operations of the data driver 950, the resonance forming unit 910, the energy storing unit 920, and the switches will be described with reference to FIG. 10.

As shown in FIG. 10, the energy supply path and the energy recovery path for forming the data signal are separated from each other. The energy storing unit 920 recovers an energy from the data electrode of the plasma display panel through the third switch 903 and the second resonance forming unit 912, and stores the energy. The energy storing unit 920 supplies an energy to the data electrode through the first resonance forming unit 911, the energy supply switch 930, and the first switch 901.

Supposing that any one channel is output in ON-OFF-ON order, the third switch S3 is turned on at a time t0, and thus the data voltage Va can be recovered from the panel. The first switch S1 and the energy supply switch 930 ES1 are turned on at a time t1, and thus the panel can be charged from the ground level voltage GND to the data voltage Va. The fourth switch S4 is turned on so as to supply the ground level voltage GND between the time t0 and the time t1.

Although FIG. 9 shows the case where the number of first switches, the number of third switches, and the number of fourth switches is one, the first, third, and fourth switches may be plural.

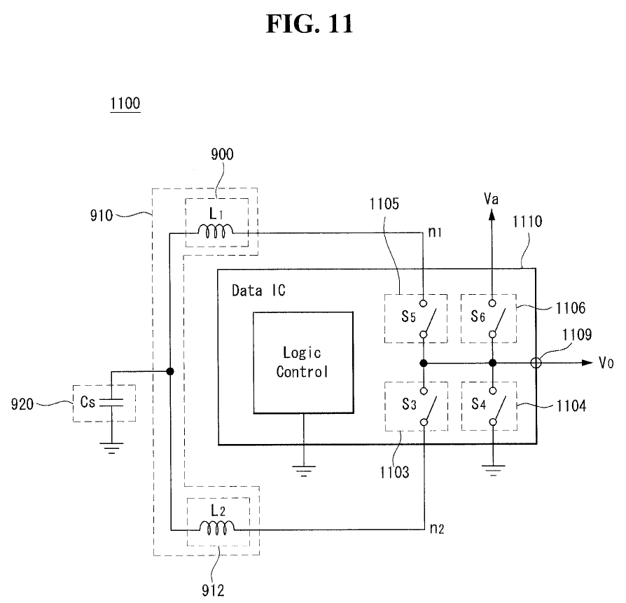

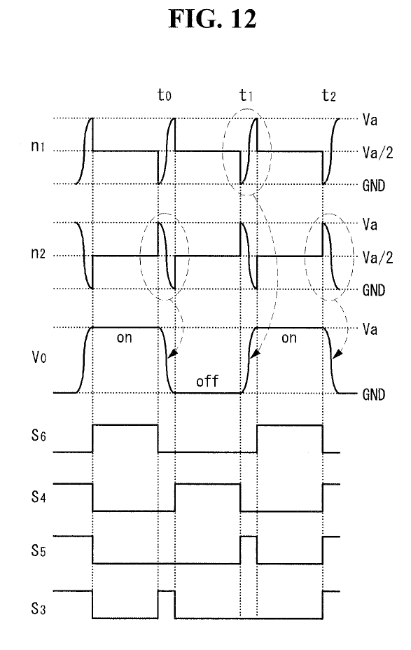

FIG. 11 shows a ninth implementation of a plasma display apparatus including a data driver, and FIG. 12 shows an example of a method of driving the plasma display apparatus of FIG. 11.

As shown in FIG. 11, the plasma display apparatus includes a data driver and an energy supply/recovery unit 1100, and the data driver and the energy supply/recovery unit 1100 include a data driver 1110 and an energy supply/recovery units 910 and 920. One terminal of the data driver 1110 is connected to an energy supply terminal n1 of the energy supply/recovery unit 910, and the other terminal is connected to an energy recovery terminal n2 of the energy supply/recovery unit 910. Both terminals of the data driver 1110 are separated from each other, and energy supply and recovery operations can be simultaneously performed through both terminals of the data driver 1110. The energy supply/recovery unit 1100 includes the resonance forming unit 910 and the energy storing unit 920.

The data driver 1110 includes a fifth switch S5 and 1105, a sixth switch S6 and 1106, a third switch S3 and 1103, and a fourth switch S4 and 1104. The fifth switch S5 and 1105 is turned on during an address period and is connected to an energy supply path. The sixth switch S6 and 1106 is connected to a path for supplying a data voltage Va corresponding to a highest voltage of a data signal. The third switch S3 and 1103 is connected to an energy recovery path. The fourth switch S4 and 1104 is connected to a path for supplying a ground level voltage GND corresponding to a lowest voltage of the data signal.

One terminal of the fifth switch 1105 is connected to the energy supply path, and the other terminal is connected to one terminal of the third switch 1103. The other terminal of the third switch 1103 is connected to the energy recovery path. One terminal of the sixth switch 1106 is connected to a data voltage supply path, and the other terminal is connected to the other terminal of the fifth switch 1105. One terminal of the fourth switch 1104 is connected to the other terminal of the fifth switch 1105, and the other terminal is connected to the ground level voltage supply path.

The data driver 1110 includes first to fifth terminals. The first terminal forms the energy supply path for forming the data signal. The second terminal forms the energy recovery path for forming the data signal. The third terminal forms a path for receiving the data voltage Va. The fourth terminal forms a path for receiving the ground level voltage GND. The fifth terminal 1109 functions as an output terminal of the data driver 1110 and is electrically connected to the data electrode of the plasma display panel.

One terminal of the fifth switch 1105 is directly connected to a first resonance forming unit 900 and L1 through the first terminal, and the other terminal is commonly connected to one terminal of the third switch 1103, one terminal of the fourth switch 1104, the other terminal of the sixth switch 1106, and the fifth terminal 1109. One terminal of the sixth switch 1106 is connected to a data voltage source for supplying the data voltage Va through the third terminal. The other terminal of the third switch 1103 is directly connected to a second resonance forming unit 912 through the second terminal. The other terminal of the fourth switch 1104 is connected to a ground level voltage source for supplying the ground level voltage GND through the fourth terminal. A description about the energy supply/recovery units 910 and 920 is omitted.

In FIG. 11, the data driver 1110 is directly connected to the first resonance forming unit L1 and 900 and the second resonance forming unit L2 and 912.

Operations of the data driver 1110, the resonance forming unit 910, the energy storing unit 920 will be described with reference to FIG. 12.

As shown in FIG. 12, the energy supply path and the energy recovery path for forming the data signal are separated from each other. The energy storing unit 920 recovers an energy from the data electrode of the plasma display panel through the third switch 1103 and the second resonance forming unit 912, and stores the energy. The energy storing unit 920 supplies an energy to the data electrode through the first resonance forming unit 900 and the fifth switch 1105.

Supposing that any one channel is output in ON-OFF-ON order, the third switch S3 is turned on at a time t0, and thus the data voltage Va can be recovered from the panel. The fifth switch S5 and an energy supply switch are turned on at a time t1, and thus the panel can be charged from the ground level voltage GND to the data voltage Va. The fourth switch S4 is turned on so as to supply the ground level voltage GND between the time t0 and the time t1. The sixth switch S6 is turned on so as to supply the data voltage Va between the time t1 and the time t2.

Because one half Va/2 of the data voltage Va is stored in the energy storing unit 920a, voltage level in the energy supply terminal n1 and the energy recovery terminal n2 is one half Va/2 of the data voltage Va.

Although FIG. 11 shows the case where the number of third switches, the number of fourth switches, the number of fifth switches, and the number of sixth switches is one, the third, fourth, fifth, and sixth switches may be plural.

As described above, the plasma display apparatus can simultaneously perform the energy supply and recovery operations by separating the energy supply path from the energy recovery path. Accordingly, energy supply and recovery time can be reduced.

Further, the plasma display apparatus can reduce the power consumption by using the bias voltage through the bias switch.

Embodiments of the invention being thus described, it will be obvious that the same may be varied in many ways. Such variations are not to be regarded as a departure from the scope of the invention, and all such modifications as would be obvious to one skilled in the art are intended to be included within the scope of the following claims.

What is claimed is:

1. A plasma display apparatus comprising:
a data driver that supplies a data signal to a plasma display panel; and
an energy supply/recovery unit including:
an energy supply unit including a first coil connected to the data driver and supplying an energy to the plasma display panel;
an energy recovery unit including a second coil connected to the data driver and recovering an energy from the plasma display panel; and
an energy storing unit connected to the energy supply unit and the energy recovery unit, the energy storing unit storing the supplied energy or the recovered energy.

2. The plasma display apparatus of claim 1, further comprising a first switch that connects the energy supply unit to the data driver.

3. The plasma display apparatus of claim 1, further comprising a second switch that connects the energy recovery unit to the data driver.

4. The plasma display apparatus of claim 1, further comprising a data voltage source connected to the energy supply unit, the data voltage source supplying a data voltage to the data driver.

5. The plasma display apparatus of claim 1, further comprising a ground level voltage source supplying a ground level voltage to the data driver.

6. The plasma display apparatus of claim 1, further comprising a bias voltage source connected to the energy recovery unit, the bias voltage source supplying a bias voltage to the data driver.

7. The plasma display apparatus of claim 6, wherein the bias voltage is greater than a ground level voltage and is smaller than a voltage for generating an address discharge.

8. The plasma display apparatus of claim 1, wherein one terminal of the data driver is connected to an energy supply terminal of the energy supply/recovery unit, and the other terminal is connected to an energy recovery terminal of the energy supply/recovery unit,
wherein both terminals of the data driver are separated from each other, and energy supply and recovery operations are simultaneously performed.

9. The plasma display apparatus of claim 1, wherein the data driver includes an 11-circuit including a first high switch and a first low switch connected in series,
a node between the first high switch and the first low switch is connected to an output terminal,
one terminal of the 11-circuit is connected to an energy supply terminal of the energy supply/recovery unit, and the other terminal is connected to an energy recovery terminal of the energy supply/recovery unit, and
both terminals of the 11-circuit are separated from each other, and energy supply and recovery operations are simultaneously performed.

10. The plasma display apparatus of claim 1, further comprising a bias unit supplying a bias voltage to the data driver,
wherein the data driver includes a 21-circuit including a second high switch and a second low switch connected in series and a bias switch connected between a node between the second high switch and the second low switch and the bias unit,
the node witch is connected to an output terminal, and
one terminal of the 21-circuit is connected to an energy supply terminal of the energy supply/recovery unit, and the other terminal is connected to a ground level.

11. The plasma display apparatus of claim 1, wherein the data driver includes a 31-circuit including a third high switch and a third bias switch connected in series and a 32-circuit including a third diode and a third low switch connected in series,
a node between the third high switch and the third bias switch is connected to an output terminal,
one terminal of the 31-circuit is connected to an energy supply terminal of the energy supply/recovery unit, and the other terminal is connected to an energy recovery terminal of the energy supply/recovery unit,
both terminals of the 31-circuit are separated from each other, and energy supply and recovery operations are simultaneously performed; and
a node between the third diode and the third low switch is connected to the output terminal, and
one terminal of the 32-circuit is connected to a data voltage source, and the other terminal is connected to a ground level.

12. The plasma display apparatus of claim 11, wherein the data driver includes a 41-circuit including a fourth high switch, a blocking diode connected in an opposite direction of a body diode of the fourth high switch, and a fourth bias switch connected in series, and a 42-circuit including a fourth diode and a fourth low switch connected in series,
a node between the blocking diode and the fourth bias switch is connected to an output terminal,
one terminal of the 41-circuit is connected to the energy supply terminal of the energy supply/recovery unit, and the other terminal is connected to the energy recovery terminal of the energy supply/recovery unit,
both terminals of the 41-circuit are separated from each other, and energy supply and recovery operations are simultaneously performed; and
a node between the fourth diode and the fourth low switch is connected to the output terminal,
one terminal of the 42-circuit is connected to the data voltage source, and the other terminal is connected to the ground level, and
body diodes of the fourth bias switch have a bidirectional blocking structure.

13. The plasma display apparatus of claim 12, wherein the body diodes of the fourth bias switch have a bidirectional blocking structure in which cathodes of the body diodes are connected to each other.

14. The plasma display apparatus of claim 1, wherein the data driver includes a 61-circuit including a sixth high switch and a sixth bias switch connected in series, and a sixth low switch of which one terminal is connected to a node between the sixth high switch and the sixth bias switch and the other terminal is connected to a ground level,
the node is connected to an output terminal,
one terminal of the 61-circuit is connected to an energy supply terminal of the energy supply/recovery unit, and the other terminal is connected to an energy recovery terminal of the energy supply/recovery unit,
both terminals of the 61-circuit are separated from each other, and energy supply and recovery operations are simultaneously performed,
body diodes of the sixth high switch have a bidirectional blocking structure,
body diodes of the sixth bias switch have a bidirectional blocking structure in an opposite direction of the body diodes of the sixth high switch, and
a node between the body diodes of the sixth high switch is connected to a data voltage source, and a node between the body diodes of the sixth bias switch is connected to a ground level.

15. The plasma display apparatus of claim 1, wherein the data driver includes a 81-circuit including an eighth high switch and an eighth bias switch connected in series, an eighth low switch of which one terminal is connected to a node between the eighth high switch and the eighth bias switch and the other terminal is connected to a ground level, and an 82-circuit including an 81-diode and an 82-diode connected in series through the node,
the node is connected to an output terminal,
one terminal of the 81-circuit is connected to a data voltage source, and the other terminal is connected to a bias voltage source,
one terminal of the 82-circuit is connected to an energy supply terminal of the energy supply/recovery unit, and the other terminal is connected to an energy recovery terminal of the energy supply/recovery unit,
both terminals of the 82-circuit are separated from each other, and energy supply and recovery operations are simultaneously performed, and
body diodes of the eighth bias switch have a bi-directional blocking structure.

16. The plasma display apparatus of claim 1, wherein the data driver includes a 83-circuit including an eighth high switch and an eighth low switch connected in series, and a 82-circuit including an 81-diode and an 82-diode connected in series through a node,
the node is connected to an output terminal,
one terminal of the 83-circuit is connected to a data voltage source, and the other terminal is connected to a ground level,
one terminal of the 82-circuit is connected to an energy supply terminal of the energy supply/recovery unit, and the other terminal is connected to an energy recovery terminal of the energy supply/recovery unit, and
both terminals of the 82-circuit are separated from each other, and energy supply and recovery operations are simultaneously performed.

17. The plasma display apparatus of claim 1, wherein the data driver includes:
a first switch of which one terminal is connected to a path for supplying a data voltage or an energy supply path;
a third switch of which one terminal is connected to the other terminal of the first switch and the other terminal is connected to an energy recovery path; and
a fourth switch of which one terminal is connected to the other terminal of the first switch and the other terminal is connected to a path for supplying a ground level voltage.

18. The plasma display apparatus of claim 1, wherein the data driver includes:
a fifth switch of which one terminal is connected to an energy supply path;
a third switch of which one terminal is connected to the other terminal of the fifth switch and the other terminal is connected to an energy recovery path;
a sixth switch of which one terminal is connected to a path for supplying a data voltage and the other terminal is connected to the other terminal of the fifth switch; and
a fourth switch of which one terminal is connected to the other terminal of the fifth switch and the other terminal is connected to a path for supplying a ground level voltage.

19. A method of driving a plasma display apparatus for supplying a data signal to a plasma display panel, wherein the data signal includes:
a rising period during which a voltage level of the data signal rises to supply the data signal to the plasma display panel;
an ON-maintenance period during which the data signal is maintained in an ON-state;
a falling period during which the voltage level of the data signal falls; and
an OFF-maintenance period during which the data signal is maintained in an OFF-state, the data signal having a predetermined bias voltage during the OFF-maintenance period.

20. The method of claim 19, wherein the bias voltage is greater than a ground level voltage and is smaller than a voltage for generating an address discharge.
